(19) United States
(12) Patent Application Publication
(10) Pub. No.: US 2008/0042433 A1
(43) Pub. Date: Feb. 21, 2008

(54) Electrical swivel connector

(76) Inventor: Stacy Smith, Simpsonville, SC (US)

Correspondence Address: Thomas A. O'Rourke;Bodner & O'Rourke, 425 Broadhollow Road, Melville, NY, 11747, US

(21) Appl. No.: 11/891,846

(22) Filed: Aug. 13, 2007

Related U.S. Application Data
(60) Provisional application No. 60/838,727, filed on Aug. 18, 2006.

(51) Int. Cl. F16L 27/00

(52) U.S. Cl. 285/276

(57) ABSTRACT

A swivel connector for a flexible hose is disclosed. The swivel connector has a housing and an end portion secured to a hose. There are electrically connective lobes on one or more rings on the end portion. The lobes on the rings contain corresponding electrically conductive wipers on an inner surface of the housing so that as the housing rotates about the end portion at least one of the lobes are in electrical contact with the wiper at all times.

This application claims priority on U.S. Provisional Patent Application Ser. No. 60/838,727 filed Aug. 18, 2006, the disclosures are incorporated herein by reference.

### FIELD OF THE INVENTION

The present invention relates generally to the field of electrical swivel connectors and more particularly to an electrical swivel connector where one or more conductive metal contact rings maintain constant contact with a wire on a connecting member around which the head swivels. The present invention has particular applicability for electric vacuum cleaner hoses and the like where the head swivels.

### BACKGROUND OF THE INVENTION

There are a variety of hoses available on the market today. One example is a vacuum cleaner hose. Some of these hoses can have a helical wire and a plastic sleeve. For some applications, the helical wire or a separate wire can be an electrical conductor so that electricity can be sent from the canister to the nozzle or other apparatus on the opposite end of the hose. A variety of electrical devices can be powered by the electricity passing through the hose. These devices can include lights for better viewing of the work area, power to drive rollers with brushes to provide deep cleaning for carpets and the like, etc.

The hoses can have a plurality of electrical conductors extending along the hose length depending on the power needs. The arrangement of the conductive wires can take on a number of different configurations depending on the type of hose and the nature of the accessories. Examples of suitable hoses with conductive wires are shown in co-pending patent application U.S. Ser. No. 10/023,473 to Moulton, the disclosures of which are incorporated herein by reference.

One type of hose arrangement that has become popular is a swivel headed hose. The swivel head permits the user to adapt the end of the hose to a variety of situations as the hose can be rotated to adjust the alignment of the head to suit the user's needs. There are a number of swivel headed hoses on the market.

When a swivel head is placed on an electric conducting hose there are frequently gaps in the electric circuitry as the head swivels during operation. These gaps can cause a power cut-off to the accessory attached to the head. In addition, it can cause arcing as the head passes from an arrangement where there is an electrical connection to one where there is not. This arcing can damage the head and cause a carbon build up that creates further areas where there is no electrical contact. For this reason, there is a need in the art for a swivel coupler to attach to a vacuum hose that will eliminate gaps in the electric circuitry, while still allowing the attachment to maintain its swiveling abilities. The use of the present invention's multi-lobed contact ring/wiper mechanism prevents precisely this type of problem from occurring.

### SUMMARY OF THE INVENTION

The present invention is directed to an electrical swivel connector for use at the end of a vacuum hose or duct system which employs preferably a system for conducting an electrical current along the hose's length utilizing contact rings with at least two lobes and semicircular wipers. The swivel connector comprises a housing and a handle which covers the handle and which provides the means of connecting the current carrying hose to the attachment at the head of the hose or duct which may require an electrical current in order to optimally clean the intended area.

The present invention is preferably utilized in a vacuum hose system and therefore, in the preferred embodiment a vacuum hose would be utilized to carry the current to the swivel headpiece. An example of a preferable type of current-carrying hose is the stretch hose described in U.S. patent application Ser. No. 10/023,73 by Moulton. This application teaches a current carrying hose capable of stretching approximately 100% its length using a thermoplastic covering which encases a helical wire that carries current throughout the hose's entire length. The thermoplastic covering has a system of peaks and valleys and a tensile strength that allows it to be stretched greatly without tearing. Furthermore, the helical wiring system which may be one of many embodiments of copper clad current-carrying wires being placed within the interior of the hose carries the electrical current along the length of the hose to the swivel head. Although the hose disclosed in the Moulton patent is preferable, however, an alternate hose or duct system may be utilized with the present swivel connector. For example, a non-stretch hose of the type frequently seen in many applications is another suitable means for carrying a current to a swivel head.

The present invention also teaches a swivel connector utilizing a handle that contains several ribs on its outer surface, used for fitting matching protrusions on the inner surface of the housing. The handle is generally cylindrical and, within the crevices created by the ribs on its outer surface are a plurality of contact rings. These rings are made of a suitable conductive material, such as copper, brass or any other appropriate metal and are secured to the outer surface of the handle. On the surface of the generally circular contact rings, preferably, is a plurality of lobes. Multiples lobes on each ring are preferable because it limits the chances of the rings coming out of contact with the connecting wipers. Thus, power loss as a result of arcing is limited and possibly even eliminated to provide a more efficient cleaning tool for users. The lobes could be any of a number of suitable shapes, however, they preferably protrude out from the ring's generally smooth round surface, having ramped sides and, preferably, a generally flat or slightly curved upper surface. They are preferably situated around the contact ring in a formation that would minimize the chances that the ring would ever be out of contact with the electrical current at any point during its swivel motion. For example, a 4-lobed ring would preferably have each ring equidistant from the others, thus each one would be 90° apart.

Utilizing a housing to provide electrical current to the swivel mechanism, the present invention has a series of correlating wipers on the inner sidewall of its housing which connect with the lobes of the contact rings and allow the rings to slide across their surface preserving the swivel ability of the device. These wipers are semicircular in the present invention but may be any suitable shape along the inner sidewall of the housing.

In an alternate embodiment, the contact rings could be on the inner sidewall of the housing and the wipers could be on the handle outer surface. In another embodiment, the present invention could have a multi-lobed wiper system with a contact ring without lobes on its surface.

### OBJECT OF THE INVENTION

Accordingly, it is an object of the invention to provide an improved swivel head for application where an electrical connection is desired.

It is also an object of the invention to provide an improved swivel head for use with a conducting hose.

It is a further object of the invention to provide an improved swivel head for a vacuum cleaner hose.

It is a still further object of the invention to provide an improved electrical conducting vacuum cleaner hose with a swivel head.

It is another object of the invention to provide an improved swivel head that provides an improved electrical connection between the hose and the accessory.

It is still another object of the invention to provide an improved swivel head that reduces the risk of arcing.

### BRIEF DESCRIPTION OF THE DRAWINGS

FIG. 1 is a cut away view of the handle.

FIG. 2 is a partial cut away view of the inner surface of the handle showing the electrical wipers fixed to the inside wall of the handle.

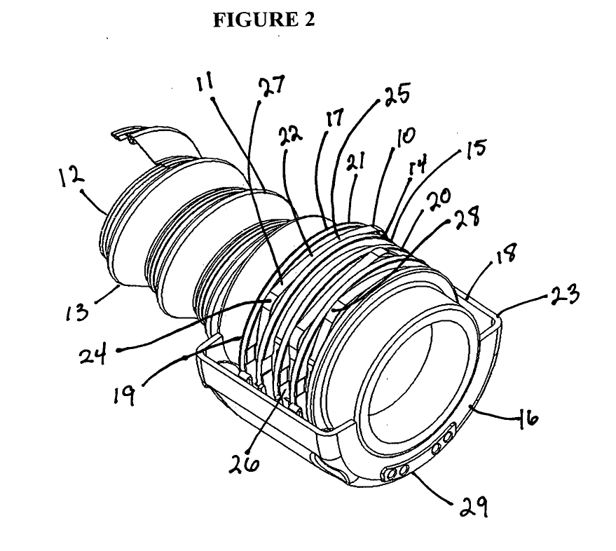

FIG. 3 shows a view of the handle and hose taken along A-A.

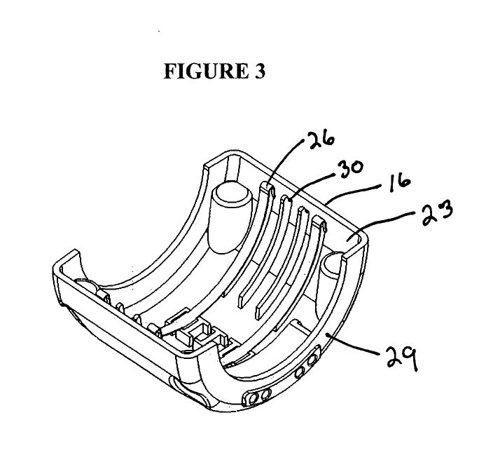

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention is directed to an electrical swivel connector 10 with an improved spring contact mechanism to enable superior electrical connection while maintaining the swivel ability sought after in the art. This swivel coupler is intended for application in the field of electrical hose and duct technology. It utilizes a spring contact on the surface of the swivel head which preferably has at least two lobes as well as semicircular wipers in order to achieve the electrical connection necessary to operate some of the mechanisms typically seen at the head of a household vacuum hose.

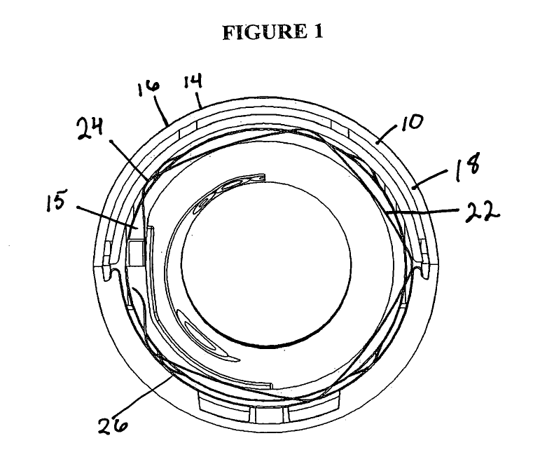

As shown in FIG. 1, there is hose 11 that can include a helical member 12 covered by a plastic coating 13. In the preferred embodiment, the hose 11 is made of a flexible material with the ability to expand greatly when tensile pressure pulling the hose 11 is applied, much like the hose described in the aforementioned published application by Moulton, Ser. No. 10/023,473. In a fully retracted position the hose 11 is compressed when there is no tensile force placed on the ends of the hose 11. In a fully extended position, the hose 11 may increase up to 100% in length when a stress is placed on it in a pulling nature. One advantage of such a hose is that in its fully retracted or compressed position, it takes up minimal space when stored and can be carried easily. Additional advantages in the use of the hose 11 when applied to a vacuum cleaning system are readily apparent, such as the ability of tile hose 11 to reach more cleaning areas without having to move the canister or bag into which the hose 11 is carrying the undesirable material. Furthermore, because the hose 11 can be stretched, it can also bend easily, allowing for a greater assistance in reaching areas which require a flexible cleaning tool in order to finish the job. Although a flexible hose 11 is preferable for the reasons stated above, in another embodiment, the hose 11 may not be flexible or stretchable in order for the present invention to apply.

Whether flexible/stretchable or not, the hose 11 comprises a helical member 12 that is made of conductive material able to carry an electrical current through the length of the entire hose 11. The helical member 12 may be any material that retains its shape and configuration in the hose 11, such as a metal or plastic wire. Preferably, the helix 12 is a steel or a copper clad steel wire helix with a thermoplastic jacket or insulation around it. The helical wire may be made by any suitable process including the process shown in U.S. Pat. No. 3,155,559 U.S. Pat. No. 3,548,724, both to Hall, the disclosures of which are incorporated herein by reference. The helical member 12 can be a single or multiple conductor wire made of metal, although, in alternate embodiment, the helical wire may be made of a fiber optic material. More preferably, there are one or more conductive wires that are helically wound along an inside surface of the hose coating. Preferably, there are at least two conductive wires helically wound along the inside surface of the plastic coating 13.

One of most important aspects of any hose 11 applicable to the present invention is the ability to carry current through its length to the swivel coupler 10 herein disclosed. This is because current carrying hoses and swivel heads are useful in applications where, for example, the vacuum cleaner has a light or motor driven cleaning device at the end of the wand. For instance many vacuum hoses have attachable and removable heads that can clean and vacuum in a variety of distinct manners. Some of these “attachments” require that an automatic motion, such as a brushing, rolling or scrubbing action be attainable through the use of a motor driven swivel head mechanism. Other vacuum systems employ a light to enhance a user's view of the cleaning area. In order for the light or motor to be operational, current is necessary. For this reason, the helix 12 is preferably made of a suitable conductive material, such as copper clad steel wire. However, it will be appreciated by those skilled in the art that other types of types of conductive wires may be used besides stranded copper and copper clad steel wire.

For example, in an alternative embodiment, there can be a non-conducting helical wire along the inside or outside surface of the hose's plastic coating 13. This helical wire may be a thermoplastic covered steel wire. There can be a pair of conducting wires, preferably made of copper wire of a gauge in the range of about 10 to about 20 with a thermoplastic jacket as the insulation, adjacent to one side of the helical member, on opposite sides of the helical wire or separated from the helical wire on the inside surface of the plastic coating. The helical wire may also be a conducting wire, a copper wire preferably insulated and coated with thermoplastic cover. In this embodiment, there is one or more additional wires helically wound along an inside surface of the plastic coating. In a still further embodiment, one ore more wires may be secured to an inside or outside surface of the plastic coating in a direction parallel to the direction of air flow through the hose. The wire may be retained in the hose by a suitable solvent, for instance, DB Acetate.

The hose 11 of the present invention also has a plastic coating 13 made up of a thermoplastic that may be a polymeric material. For example, any thermoplastic material such as ethylene vinyl acetate (EVA), polyvinyl chloride (PVC) and others will be sufficient to achieve the insulation and flexibility properties desirable in the plastic coating of the hose. Typically, this plastic has a thickness of about 10 mil to 50 mil.

At the end of the hose 11 is typically attached any of the various operational “head” mechanisms necessary for various cleaning tasks and attachment means for securing the piece to the hose's end. In the preferred embodiment, the swivel head attachment 14 has a handle 15 and a housing 16 that surrounds the handle. The handle 15 is in the form of a cylindrical member having a first 17 and second end 18. The first end 17 is attached to the hose end 19 by any suitable means, including, but not limited to, an adhesive or head seal. Another suitable means would be a fastening mechanism, whereby the handle 15 would have on its end a protruding member which could be fitted into a complimentary orifice on the end of the hose 19 onto which the handle 15 is to be attached. In this manner the protruding member of the handle 15 would fit tightly into orifice using one of variety of locking mechanisms practical to one skilled in the art. For example, the protruding member could have a tip that is larger than its stem, and which has a bottom surface that is roughly perpendicular to the stem, so that it may fit through the orifice and snap into place like a bayonet lock. Any other locking mechanism known in the art would be suitable. The surface of the handle 20 is circular and the preferably has a series of grooves made 21 up of peaks and valleys and into which the corresponding pieces of the housing can fit. The opposite end of the handle 18 may be secured to a suitable accessory utilizing the grooves 21 in the surface of the handle 20 to tighten the accessory's attachment to the handle 15 and the hose 11 itself.

Attached to the outer surface of the handle 20 are one or more conductive rings 22 usually made from a suitable metal such as brass, copper, aluminum, etc. These rings 22 may be secured to the surface of the handle 20 by any suitable means. For instance, in the preferred embodiment, the rings 22 are attached to the outer surface of the handle 20 using an adhesive substance. However, in one embodiment the surface of the handle 20 may be provided with a plurality of ribs which form a plurality of recessed portions in which there are the conductive rings 22. In this embodiment, the ribs act as a securing mechanism for holding the rings 22 in place around the outer surface of the handle 20. These ribs also serve the purpose of interacting with corresponding conductive pieces on the inner surface of the housing 23 that secure the housing 16 and the handle 15 together, but also allow each to rotate within the canals created by the ribs, preserving the swivel feature of the head piece 14.

The conductive rings 22 on the handle 15 have one or more lobes 24 extending outwardly from the outer surface of the conductive ring 25. There are preferably at least two lobes 24 on the outer surfaces of the rings 25. In these embodiments, the lobes 24 will be positioned so that at all points of rotation, at least one of the contact lobes 24 will be connected to the corresponding wipers 26 on the housing 16. This is preferable because it prevents loss of electrical connection at any point in the head piece's swiveling action, and thus, the power necessary for the operation of the brushes or lights attached to the open end of the hose 18 will not be disconnected. Furthermore, these embodiments with a plurality of contact lobes 24 prevent arcing which occurs when the lobes 24 come out of contact with the corresponding wipers 26 and release electrical sparks outward when approaching the wiper 26 again.

In one embodiment there are four lobes 24 equidistant around the circumference of the ring 22. In another embodiment, there are five lobes 24 generally 75° apart around the circumference of the ring 22. The rings 22 are generally round except in the region of the lobes 24 where there is typically a ramp section 27 on each side of a contact section 28. The ramps 27 each converge at a relatively flat or rounded plateau, which is the point that will remain in contact with the wiper. It will be appreciated by those skilled in the art that the lobes 24 can have a variety of different configurations as long as they provide a plurality of contact points along the circumference of the ring 22.

The housing 16 portion of the swivel connector 10 is generally cylindrical in the preferred embodiment and is shaped proportionally to the handle 15, but with a slightly larger circumference so that it provides an encasement of the handle 15. The housing 16 is characterized by an inner sidewall 23 and an outer sidewall 29. The outer sidewall 29 is generally flat or perhaps has a means for gripping it properly such as grooves for fingers to wrap around it. Nevertheless, the inner surface 23 has a series of ribs 30 on it as well as a plurality of conductive wipers 26, of the same or a similar material as the conductive rings 22. The wipers 26 are preferably semicircular in shape, however, they may be circular in shape along the entire inner sidewall of the housing 23 alternately, or they may even be a series of curved pieces at various intervals along the inner sidewall of the housing 23. However, it is important that the conductive rings have the ability to rotate along the length of the wipers 26, and that, in the preferred embodiment, at least one of the lobes of the contact rings 24 be in contact with the wipers 26 at all times.

What is claimed is:

1. A swivel connector for a hose comprising an end portion on an end of a flexible hose containing one or more electrical conducting wires, and an outer housing, said housing being rotatably connected to said end portion, said end portion having one or more circular grooves in an outer surface of said end portion, one or more of said grooves having an electrically conductive ring portion in said groove, at least one of said conductive ring portions having an electrically conductive lobe extending outwardly from an outer surface of the conductive ring portion;
said housing having an interior surface and an exterior surface and having one or more conductive wipers on said interior surface, at least one lobe on said end portion being in contact with at least one wiper at all times as said housing rotates about said end portion.

2. The connector according to claim 1 wherein said ring portion is circular.

3. The connector according to claim 2 wherein said conductive ring portion has a plurality of lobes extending outwardly from said ring portion, said lobes being equidistant around the surface of said ring.

4. The connector according to claim 3 wherein there are four lobes around said ring portion.

5. The connector according to claim 3 wherein there are five lobes around said ring portion.

6. The connector according to claim 3 wherein there are a plurality of circular rings on said end portion and each of said rings has a plurality of lobes extending therefrom.

7. The connector according to claim 6 wherein each ring has a corresponding wiper.

8. The connector according to claim 1 wherein said lobe has a ramp section on each side of a contact section.

9. The connector according to claim 8 wherein said contact section is flat.

10. The connector according to claim 8 wherein said contact section is curved.

11. The connector according to claim 1 wherein said conductive rings are made from the same material as said wipers.

12. The connector according to claim 1 wherein said wiper is circular.

13. The connector according to claim 1 wherein said wiper is a portion of an arc.
